(19) United States
(12) Patent Application Publication
(10) Pub. No.: US 2012/0310782 A1
(43) Pub. Date: Dec. 6, 2012

(54) SYSTEM FOR USER TO USER PAYMENTS FACILITATED BY A THIRD PARTY

(75) Inventors: Kishore V. Konakanchi, San Jose, CA (US); Phillip Hughes Allen, Aptos, CA (US); Mark Fister, Salt Lake City, UT (US)

(73) Assignee: eBay Inc., San Jose, CA (US)

(21) Appl. No.: 13/432,436

(22) Filed: Mar. 28, 2012

Related U.S. Application Data
(60) Provisional application No. 61/493,311, filed on Jun. 3, 2011.

(51) Int. Cl. G06Q 30/06; G06Q 10/08

(52) U.S. Cl. 705/26.81

(57) ABSTRACT

A transaction request is received from a buyer for an item listed by a seller in an online marketplace. A tiered status of funds availability to the seller for the transaction request is generated based on a profile of the seller, a funds hold and release criteria, and a shipping status of the item.

### CROSS-REFERENCE TO RELATED APPLICATION

This application claims the benefit of U.S. Provisional Application No. 61/493,311, filed Jun. 3, 2011, entitled “A SYSTEM FOR USER TO USER PAYMENTS FACILITATED BY A THIRD PARTY,” which is incorporated herein by reference in its entirety.

### TECHNICAL FIELD

This application relates generally to the field of computer technology, and in a specific example embodiment, to a method and system for user to user payments facilitated by a third party.

### BACKGROUND

Electronic commerce has flourished because buyers and sellers are able to connect with each other through online marketplace websites. The online marketplace website typically withholds funds from a buyer to the seller until the seller has shipped the item purchased by the buyer or until the buyer has received the item. Thus, sellers are eagerly anticipating receiving their payments and constantly wary of the status of when the funds from the buyer will be released by the online marketplace website. Most sellers are required to wait for “x” days after shipping before funds are available to them.

Furthermore, buyers and sellers may have poor online transaction experience. One of the primary reasons for a poor buyer experience includes the lack of buyer protection coverage in case the shipment has not been received. One reason for a poor seller experience includes a lack of a transparent funds hold policy by the online marketplace website.

### BRIEF DESCRIPTION OF THE DRAWINGS

Embodiments of the present application illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of the funds availability status application of FIG. 1;

FIG. 3 is a block diagram illustrating an example embodiment of a seller profile;

FIG. 4 is a block diagram illustrating an example embodiment of a shipping status;

FIG. 5 is a block diagram illustrating an example embodiment of a tiered status of funds availability;

FIG. 6 is a block diagram illustrating an example embodiment of a funds hold and release criteria;.

FIG. 7 is a block diagram illustrating an example embodiment of a process flow for generating a tiered status of funds availability;

FIG. 8 is a flow diagram illustrating an example embodiment of a method for generating a tiered status of funds availability;

FIG. 9 is a flow diagram illustrating another example embodiment of a method for generating a tiered status of funds availability; and

FIG. 10 shows a diagrammatic representation of a machine in the example form of a computer system within which a set of instructions may be executed to cause the machine to perform any one or more of the methodologies discussed herein;

### DETAILED DESCRIPTION

Although the present application has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

A system and method for generating a tiered status of funds availability to a seller of an online marketplace is described. A transaction request is received from a buyer for an item listed by the seller in the online marketplace. A tiered status of funds availability to the seller for the transaction request is generated based on the profile of the seller, a funds hold and release criteria, and a shipping status of the item.

In a common online marketplace scenario, sellers are required to ship before they have access to funds. Most sellers will be required to wait for “x” number of days after shipping (marking as shipped, printing a label, uploading tracking number) before funds are available. One reason for a poor seller experience is a lack of a transparent funds hold policy by the online marketplace.

As part of the present disclosure, a system is described for user to user payments that are facilitated by a partner (who is not necessarily the sender or the receiver) to allow the partner to control the timing of the receiver having full access to the already sent funds from the buyer.

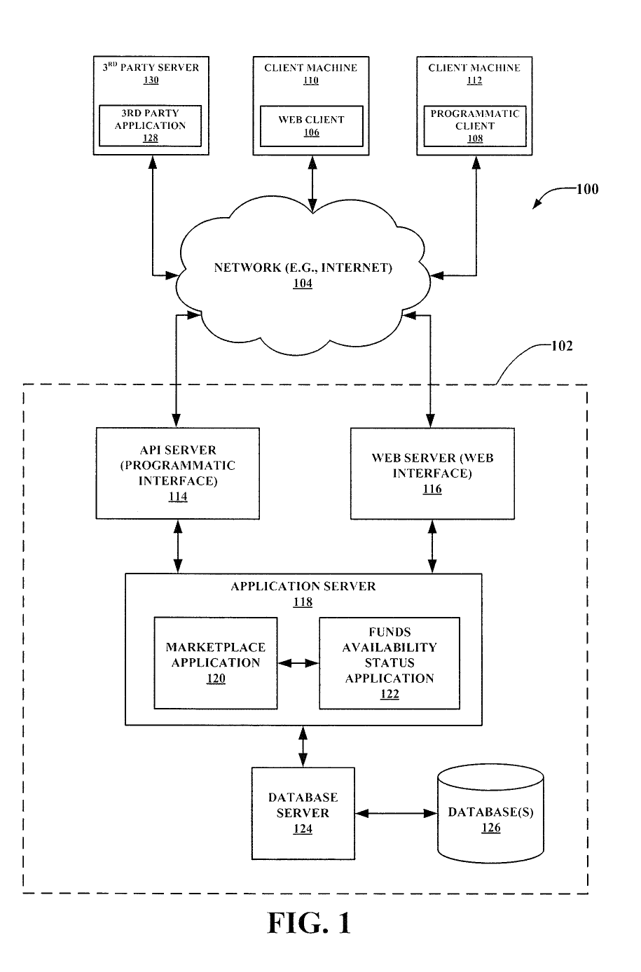

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a funds availability status application 122, may provide server-side functionality, via a network 104 (e.g., the Internet) to one or more clients. The one or more clients may include users that utilize the network system 100 and more specifically, the marketplace application 120 and the funds availability status application 122, to exchange data over the network 104. These transactions may include transmitting, receiving (communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among other things.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments the client machines 110, 112, or third party server 130 may be associated with a buyer, a seller, a third party electronic commerce platform, a payment service provider, a shipping service provider, and/or a financial institution system, each in communication with the network-based publisher 102 and, optionally, each other. The buyers and sellers may be any one of individuals, merchants, or service providers, among other things.

In one embodiment, the third party server 130 is associated with a financial service provider that receives funds from the buyer and holds the funds for the seller pending a shipment of an item of a commercial transaction request being fulfilled and completed.

Turning specifically to the marketplace application 120 and the funds availability status application 122, an application program interface (API) server 114 and a web server 116 are coupled to, and provide programmatic and web interfaces respectively to, one or more application servers 118. The application server 118 hosts one or marketplace applications 120 and the funds availability status application 122. The application server 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods and/or services (e.g., for sale) published on the marketplace application 120. In one embodiment, the marketplace application 120 receives a transaction request from a buyer for an item listed by a seller in an online marketplace.

In one embodiment, the funds availability status application 122 provides a tiered status of funds availability to the seller (e.g. “order received—please ship,” “shipped—pending availability,” or “available”) instead of a dual status such as “available” and “on hold.” The tiered status of funds availability provides the seller a more granular feel of a process with more details than the “hold” status. In another embodiment, the funds availability status application 122 can refer the seller to the funds holding policy and emphasize that the third party server 130 is in control of the hold and release of the funds.

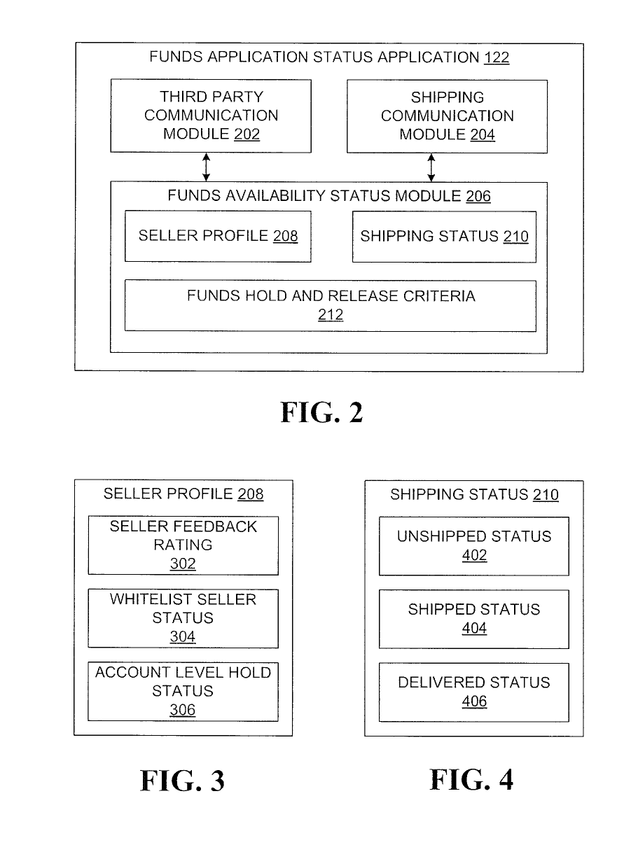

FIG. 2 is a block diagram illustrating an example embodiment of the funds status application of FIG. 1. The funds availability status application 122 includes a third party communication module 202, a shipping communication module 204, and a funds availability status module 206.

The third-party communication module 202 is configured to communicate with the third party server 130 in receipt of funds from a buyer for the item listed by the seller on the online marketplace application 120. The third party server 130 controls a hold and release of the funds from the buyer to the seller based on a tiered status of funds availability generated by the funds availability status module 206.

In one embodiment, the third-party server 130 acts as an independent financial escrow intermediary between the seller and the buyer. In other words, the third-party server 130 may act independently of the marketplace application 120. The third-party server 130 is configured to receive funds from the buyer for a transaction request based on an item listed by the seller on the online marketplace 120.

In another embodiment, the third-party communication module 202 may communicate funds hold and release instructions to the third-party server 130. The third-party communication module 202 may also be configured to receive a confirmation from the third-party server 130 of funds being settled to an account as a pending balance. In another embodiment, the third-party communication module 202 may receive a hold and release policy, rule, or criteria based on the profile of the seller. For example, the third-party server 130 may communicate to the third-party communication module 202 that the seller is confirmed, white listed, confirmed with downgrade, or on an account level hold. The terms are further defined below.

In one embodiment, the shipping communication module 204 communicates with a shipping carrier server associated with the transaction request of the buyer on the online marketplace. The shipping communication module 204 may submit a shipping tracking identifier from the seller to the shipping carrier server. The shipping communication module 204 receives a shipping status from the shipping carrier server associated with the shipping tracking identifier. The shipping status includes, for example, a last known location of the package containing the item of the transaction request and a date and time associated with the last known location. In another example, the shipping status includes an estimated delivery date.

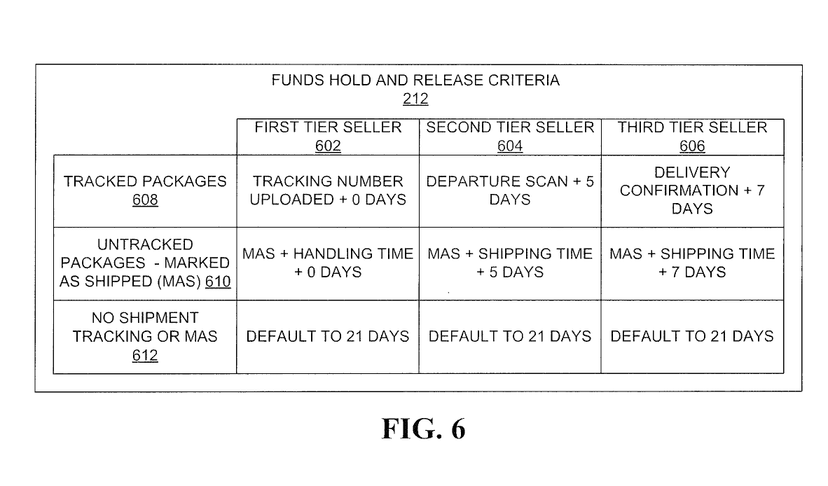

The funds availability status module 206 generates a tiered status of funds availability to the seller for the transaction request based on the profile of the seller, funds hold and release criteria, and shipping status of the item. The tiered status of funds availability includes at least three statuses (such as “order received—please ship,” “shipped—pending availability,” and “available”) instead of two statuses (such as “available” and “on hold”). Furthermore, the tiered status of funds availability is based on the profile of the seller, the funds hold and release criteria, and the shipping status of the item. In one embodiment, the funds availability status module 206 includes a seller profile module 208, a shipping status module 210, and a funds hold and release criteria module 212. The seller profile module 208 is discussed in more detail below with respect to FIG. 3. The shipping status module 210 is discussed in more detail below with respect to FIG. 4. The funds hold and release criteria module 212 may include policies and rules on whether to hold the funds and for how long. An example of the funds hold and release criteria module 212 is illustrated and described in more detail below with respect to FIG. 6.

FIG. 3 is a block diagram illustrating an example embodiment of the seller profile module 208. The seller profile module 208 contains a profile of the seller with respect to the online marketplace 120. In another embodiment, the profile of the seller may also be based on other websites, such as other online marketplaces or social networking websites. The seller profile module 208 includes, for example, a seller feedback rating 302, a white list seller status 304, and an account level hold status 306. The seller feedback rating 302 may include a feedback rating of the seller based on previous transactions conducted on the online marketplace 120. In another embodiment, the feedback rating of the seller may also be based on previous transactions conducted on other websites. The seller profile module 208 influences the timing of the release of funds. For example, a seller with a higher seller feedback rating will most likely have the funds released sooner than later. In other words, the hold time period of the funds may be minimal. In one embodiment, a seller included in a white list seller status 304 may also have the funds released sooner than later. In other words, the white list seller status 304 forms an exception to the process of the hold and release criteria. An account level hold status 306 may indicate that the seller poses a high risk, is a new seller, or has no positive transaction track record.

FIG. 4 is a block diagram illustrating an example embodiment of the shipping status module 210. The shipping status module 210 may include, for example, an unshipped status 402, a shipped status 404, and a delivered status 406. In another embodiment, the shipping status module 210 may include further details, such as the tracking identifier of the shipped item, whether the item has been shipped but without a tracking identifier, whether the shipped item has been registered at a first point of receipt, whether the shipped item is out for delivery, and whether the shipped item has been delivered with or without a signature confirmation. The delivered status 406 may also include a delivery time and date.

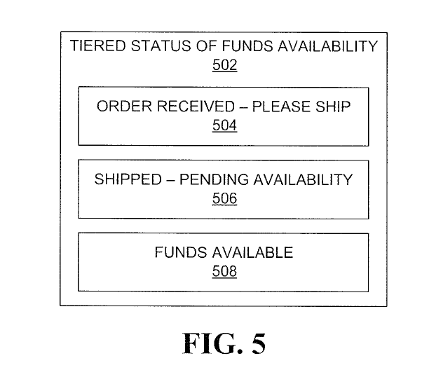

FIG. 5 is a block diagram illustrating an example embodiment of a tiered status of funds availability 502. In one embodiment, the first funds availability status may include a notice of the transaction request and an instruction for the seller to ship the item. The second funds availability status includes a notice of pending funds status upon the item being shipped. The third funds availability status includes a notice of available funds status.

For example, the tiered status of funds availability includes: a first tier 504 entitled “order received—please ship,” a second tier 506 entitled “shipped—pending availability,” and a third tier 508 entitled “funds available.” Furthermore, the tiered status of funds availability may be based on the profile of the seller, the funds hold and release criteria, and the shipping status of the item.

In another embodiment, the tiered status of funds availability 502 may include more than three tiers and may include more detailed information as to when the funds will be released to the seller (such as, for example, an estimated funds release date). The tiered status of funds availability 502 provides a better estimate for the seller of when the funds will be received for the transaction request.

FIG. 6 is a block diagram illustrating an example embodiment of a funds hold and release criteria module 212. The funds hold and release criteria 212 may be based on first tier sellers 602, second tier sellers 604, and third tier sellers 606. In one embodiment, the first tier sellers 602 include, for example, long established sellers with a consistent positive track record of shipping items on time with mainly positive feedbacks from previous buyers. The second tier sellers 604 include, for example, sellers with a positive track record of shipping items on time with mostly positive feedbacks from previous buyers. The third tier sellers 606 include, for example, new sellers, sellers with a poor track record of shipping items online or with mostly negative feedbacks from previous buyers, or sellers categorized as high risk sellers.

The funds hold and release criteria 212 may be based on the manner in which the packages containing the item are tracked or shipped. Tracked packages 608 may include packages shipped with a tracking number. Untracked packages marked as shipped (MAS) 610 may include packages marked as shipped without a tracking number. No shipment tracking or MAS 612 may include packages that do not contain any tracking number and have not been identified as marked as shipped.

For example, the funds hold and release criteria for first tier sellers 602 with tracked packages 608 includes releasing the funds within zero days after the tracking number has been uploaded. The funds hold and release criteria for first tier sellers 602 with untracked packages marked as shipped 610 includes releasing the funds within zero days after receiving marked as shipped from the sellers. A handling time for the seller may be factored in the criteria. The funds hold and release criteria for first tier sellers 602 with no shipment tracking or marked as shipped includes releasing the funds after 21 days from the date of the transaction.

The funds hold and release criteria for second tier sellers 604 with tracked packages 608 includes releasing the funds within five days after the tracking number has been uploaded. The funds hold and release criteria for second tier sellers 604 with untracked packages marked as shipped 610 includes releasing the funds within five days after receiving marked as shipped from the sellers. The funds hold and release criteria for second tier sellers 604 with no shipment tracking or marked as shipped includes releasing the funds after 21 days from the date of the transaction.

The funds hold and release criteria for third tier sellers 606 with tracked packages 608 includes releasing the funds within seven days after the tracking number has been uploaded. The funds hold and release criteria for third tier sellers 606 with untracked packages marked as shipped 610 includes releasing the funds within five days after receiving marked as shipped from the sellers. The funds hold and release criteria for third tier sellers 606 with no shipment tracking or marked as shipped includes releasing the funds after 21 days from the date of the transaction.

In another embodiment, the funds hold period may be dynamically adjusted to provide more granularities based on the above factors and based on other criteria. In other words, the time range of funds hold period can vary as well as how many tiered sellers can be defined in the time range.

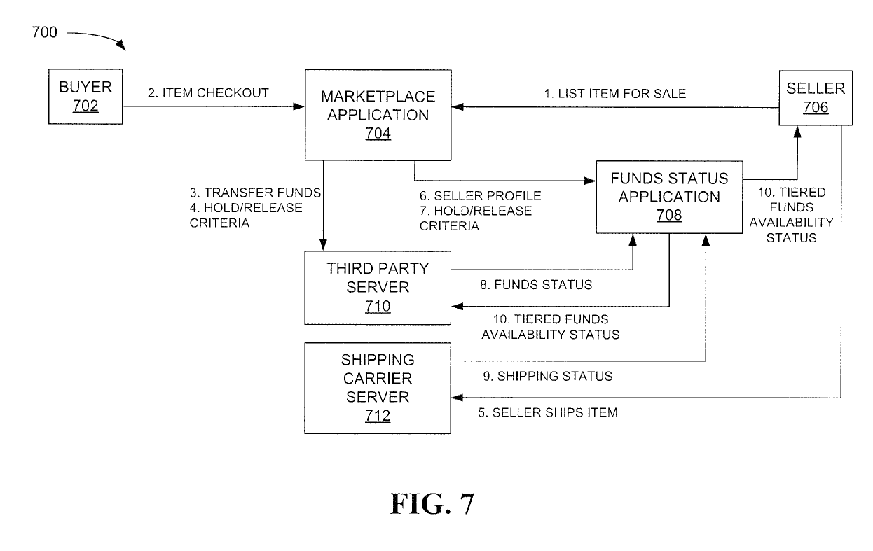

FIG. 7 is a block diagram illustrating an example embodiment of a process 700 for generating a tiered status of funds availability. A seller 706 lists an item for sale on the marketplace application 704. A buyer 702 submits a transaction request to purchase the item listed by the seller 706 on the marketplace application 704. The buyer 702 checks out on the marketplace application 704. Funds from the buyer 702 are collected by a third-party server 710. The third-party server 710 also receives hold and release criteria or rules from marketplace application 704. The marketplace application 704 notifies the seller 706 that the buyer 702 has purchased the item from the seller 706. The seller 706 ships the item in a package using the services of a shipping carrier. The seller 706 may obtain or submit a tracking number with shipping carrier server 712. The funds status application 708 receives a profile of the seller, the status of whether the funds have been received from the buyer 702, and a shipping status of the package. The funds status application 708 generates a tiered funds availability status and communicates it to the seller 706 and to the third-party server 710.

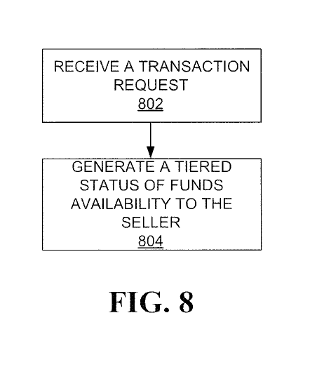

FIG. 8 is a flow diagram illustrating an example embodiment of a method for generating a tiered status of funds availability. At operation 802, a transaction request is received from a buyer for an item listed by a seller in an online marketplace. At operation 804, a tiered status of funds availability to the seller for the transaction request is generated based on the profile of the seller, funds hold and release criteria, and shipping status of the item.

In one embodiment, a funds availability status application 122 communicates with a third party server in receipt of funds from the buyer for the item listed by the seller. The third party server controls a hold and release of the funds from the buyer to the seller based on the tiered status of funds availability.

In one embodiment, the tiered status of funds availability comprises a first funds availability status, a second funds availability status, and a third funds availability status. For example, the first funds availability status comprises a notice of the transaction request and an instruction for the seller to ship the item. The second funds availability status comprises a notice of pending funds status upon the item being shipped. The third funds availability status comprises a notice of available funds status.

The profile of the seller comprises, for example, a feedback rating of the seller, a whitelist seller status, and an account level hold status.

In one embodiment, the third party server releases the funds faster for a seller with a higher feedback rating than for a seller with a lower feedback rating. For a seller with a whitelist seller status, the third party server does not hold the funds and releases the funds almost immediatly. For a seller with an account level hold status, the third party server holds the funds for a predetermined period of time and does not release the funds to the seller until an exception is triggered.

In one embodiment, the funds hold and release criteria comprise rules for holding the funds from the buyer for up to a maximum number of days and rules for releasing the funds to the seller.

For example, the shipping status of the item comprises an unshipped status, a shipped status, and a delivered status.

The shipping status of the item comprises a tracked package status, an untracked package MAS status, and a no-shipment tracking status. In a first example, the third party server holds the funds for a first number of days for a first tier of sellers with the tracked package status, for a second number of days for the first tier of sellers with the tracked package status, and for a third number of days for the first tier of sellers with the tracked package status.

In a second example, the third party server holds the funds for a fourth number of days for a second tier of sellers with the untracked package MAS status, for a fifth number of days for the second tier of sellers with the untracked package MAS status, and for a sixth number of days for the second tier of sellers with the untracked package MAS status.

In a third example, the third party server holds the funds for a seventh number of days for a third tier of sellers with the no-shipment tracking status, for an eighth number of days for the third tier of sellers with the no-shipment tracking status, for a ninth number of days for the third tier of sellers with the no-shipment tracking status.

The first and second numbers of days are respectively less than the fourth and fifth number of days, and the fourth and fifth numbers of days are less than the seventh and ninth number of days. In one embodiment, the third, sixth, and eighth number of days are more than the first, second, fourth, fifth, seventh, and ninth number of days. The third tier of seller may include sellers determined as high risk based on their profiles.

In another embodiment, the funds status application communicates with a shipping carrier server associated with the transaction request, submits a shipping tracking identifier from the seller to the shipping carrier server, and receives the shipping status from the shipping carrier server based on the shipping tracking identifier.

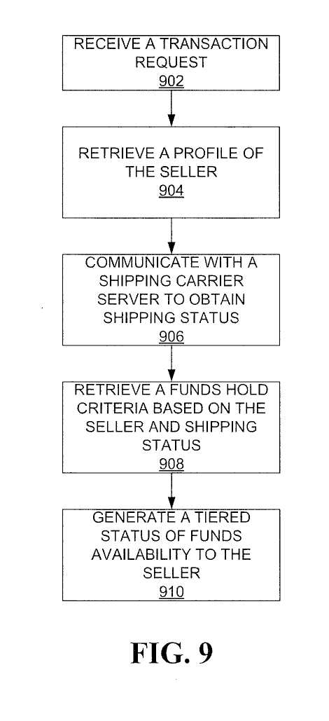

FIG. 9 is a flow diagram illustrating another example embodiment of a method for generating a tiered status of funds availability. At operation 902, a transaction request is received from a buyer for an item listed by a seller in an online marketplace. At operation 904, a profile of the seller is retrieved. At operation 906, the funds status application communicates with a shipping carrier server to obtain a shipping status of the item from the transaction request. The funds hold and release criteria are retrieved based on the seller profile and the shipping status at operation 908. At operation 910, a tiered status of funds availability to the seller for the transaction request is generated based on the profile of the seller, the funds hold and release criteria, and the shipping status of the item.

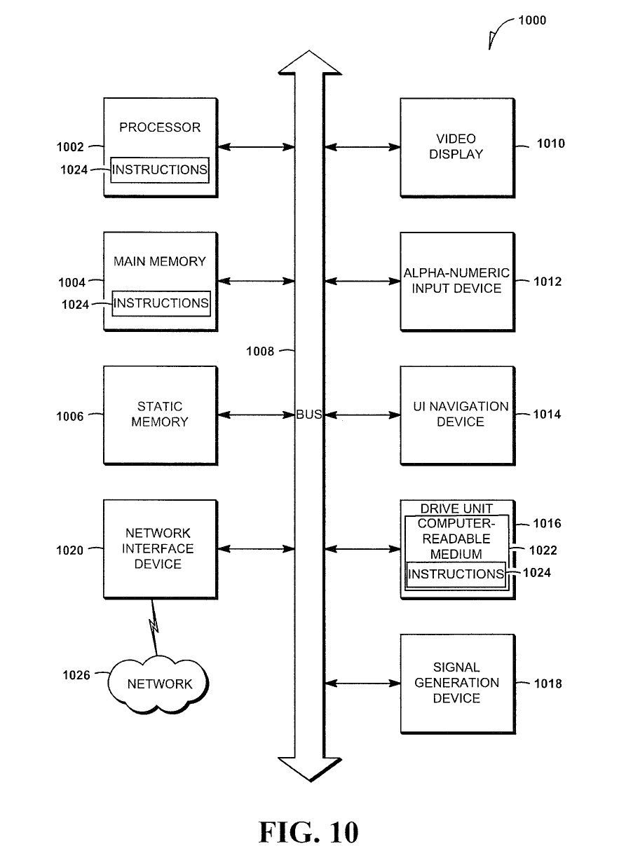

FIG. 10 shows a diagrammatic representation of a machine in the example form of a computer system 1000 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a UI navigation device 1014 (e.g., a mouse), a disk drive unit 1016, a signal generation device 1018 (e.g., a speaker), and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, with the main memory 1004 and the processor 1002 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a marketplace module configured to receive a transaction request from a buyer for an item listed by a seller in an online marketplace; and
a funds availability status module of a processor configured to generate a tiered status of funds availability to the seller for the transaction request based on a profile of the seller, a funds hold and release criteria, and a shipping status of the item.

2. The system of claim 1, further comprising:
a third party module configured to communicate with a third party server in receipt of funds from the buyer for the item listed by the seller, the third party server to control a hold and release of the funds from the buyer to the seller based on the tiered status of funds availability.

3. The system of claim 1, wherein the tiered status of funds availability comprises a first funds availability status, a second funds availability status, and a third funds availability status.

4. The system of claim 3, wherein the first funds availability status comprises a notice of the transaction request and an instruction for the seller to ship the item,
wherein the second funds availability status comprises a notice of pending funds status upon the item being shipped; and
wherein the third funds availability status comprises a notice of available funds status.

5. The system of claim 2, wherein the profile of the seller comprises a feedback rating of the seller, a whitelist seller status, and an account level hold status,
wherein the third party server releases the funds faster for a seller with a higher feedback rating than for a seller with a lower feedback rating,
wherein the third party server does not hold the funds and releases the funds to a seller with the whitelist seller status; and
wherein the third party server holds the funds for a predetermined period of time and does not release the funds to the seller until an exception is triggered for a seller with the account level hold status.

6. The system of claim 1, wherein the funds hold and release criteria comprise rules for holding funds from the buyer for up to a maximum number of days and rules for releasing the funds to the seller.

7. The system of claim 2, wherein the shipping status of the item comprises an unshipped status, a shipped status, and a delivered status.

8. The system of claim 2, wherein the shipping status of the item comprises a tracked package status, an untracked package marked as shipped status, and a no-shipment tracking status,
wherein the third party server holds the funds for a first number of days for a first tier of sellers with the tracked package status, for a second number of days for the first tier of sellers with the tracked package status, and for a third number of days for the first tier of sellers with the tracked package status,
wherein the third party server holds the funds for a fourth number of days for a second tier of sellers with the untracked package marked as shipped status, for a fifth number of days for the second tier of sellers with the untracked package marked as shipped status, for a sixth number of days for the second tier of sellers with the untracked package marked as shipped status; and
wherein the third party server holds the funds for a seventh number of days for a third tier of sellers with the no-shipment tracking status, for an eighth number of days for the third tier of sellers with the no-shipment tracking status, for a ninth number of days for the third tier of sellers with the no-shipment tracking status,
wherein the first and second number of days are respectively less than the fourth and fifth number of days, and the fourth and fifth number of days are less than the seventh and ninth number of days.

9. The system of claim 8, wherein a seller is determined to be high risk based on the profile of the seller corresponding to the third tier of sellers.

10. The system of claim 1, further comprising a shipping carrier module configured to communicate with a shipping carrier server associated with the transaction request to submit a shipping tracking identifier from the seller to the shipping carrier server and to receive the shipping status from the shipping carrier server based on the shipping tracking identifier.

11. A computer-implemented method comprising:
receiving a transaction request from a buyer for an item listed by a seller in an online marketplace: and
generating, with at least one processor, a tiered status of funds availability to the seller for the transaction request based on a profile of the seller, a funds hold and release criteria, and a shipping status of the item.

12. The computer-implemented method of claim 11, further comprising:
communicating with a third party server in receipt of funds from the buyer for the item listed by the seller, the third party server to control a hold and release of the funds from the buyer to the seller based on the tiered status of funds availability.

13. The computer-implemented method of claim 11, wherein the tiered status of funds availability comprises a first funds availability status, a second funds availability status, and a third funds availability status.

14. The computer-implemented method of claim 13, wherein the first funds availability status comprises a notice of the transaction request and an instruction for the seller to ship the item,
wherein the second funds availability status comprises a notice of pending funds status upon the item being shipped; and
wherein the third funds availability status comprises a notice of available funds status.

15. The computer-implemented method of claim 12, wherein the profile of the seller comprises a feedback rating of the seller, a whitelist seller status, and an account level hold status,
wherein the third party server releases the funds faster for a seller with a higher feedback rating than for a seller with a lower feedback rating,
wherein the third party server does not hold the funds and releases the funds to a seller with the whitelist seller status; and
wherein the third party server holds the funds for a predetermined period of time and does not release the funds to the seller until an exception is triggered for a seller with the account level hold status.

16. The computer-implemented method of claim 11, wherein the funds hold and release criteria comprise rules for holding the funds from the buyer for up to a maximum number of days and rules for releasing the funds to the seller.

17. The computer-implemented method of claim 12, wherein the shipping status of the item comprises an unshipped status, a shipped status, and a delivered status.

18. The computer-implemented method of claim 12, wherein the shipping status of the item comprises a tracked package status, an untracked package marked as shipped status, and a no-shipment tracking status,
wherein the third party server holds the funds for a first number of days for a first tier of sellers with the tracked package status, for a second number of days for the first tier of sellers with the tracked package status, and for a third number of days for the first tier of sellers with the tracked package status,
wherein the third party server holds the funds for a fourth number of days for a second tier of sellers with the untracked package marked as shipped status, for a fifth number of days for the second tier of sellers with the untracked package marked as shipped status, for a sixth number of days for the second tier of sellers with the untracked package marked as shipped status; and
wherein the third party server holds the funds for a seventh number of days for a third tier of sellers with the no-shipment tracking status, for an eighth number of days for the third tier of sellers with the no-shipment tracking status, for a ninth number of days for the third tier of sellers with the no-shipment tracking status,
wherein the first and second number of days are respectively less than the fourth and fifth number of days, and the fourth and fifth number of days are less than the seventh and ninth number of days,
wherein a seller is determined to be high risk based on the profile of the seller corresponding to the third tier of sellers.

19. The computer-implemented method of claim 11, further comprising:
communicating with a shipping carrier server associated with the transaction request;
submitting a shipping tracking identifier from the seller to the shipping carrier server; and
receiving the shipping status from the shipping carrier server based on the shipping tracking identifier.

20. A non-transitory computer-readable storage medium storing a set of instructions that, when executed by a processor, cause the processor to perform operations, comprising:
receiving a transaction request from a buyer for an item listed by a seller in an online marketplace; and
generating a tiered status of funds availability to the seller for the transaction request based on the profile of the seller, a funds hold and release criteria, and a shipping status of the item.
